(19) United States
(12) Patent Application Publication
(10) Pub. No.: US 2012/0004899 A1
(43) Pub. Date: Jan. 5, 2012

(54) DYNAMIC AD SELECTION FOR AD DELIVERY SYSTEMS

(76) Inventor: Taymoor Arshi, Potomac, MD (US)

(21) Appl. No.: 12/830,332

(22) Filed: Jul. 4, 2010

(51) Int. Cl. G06F 15/16; G06F 17/20

(52) U.S. Cl. 704/8; 709/217

(57) ABSTRACT

Systems and systems are disclosed for a portable device that employs voice recognition and/or encoding/decoding techniques which may be employed to gather, analyze and identify the media's content class, language being spoken, topic of conversation and/or other information which may be useful in selecting targeted advertisements. The portable device uses this information to produce dynamic research data descriptive of the nearby natural languages and/or content. Once the portable device has produced dynamic research data, it communicates any dynamic research data to a centralized server system server where the dynamic research data is processed and used to select the one or more most suitable targeted advertisement. The selected targeted advertisement is then communicated to and/or inserted in the ad delivery device. Alternatively, the portable device may communicate dynamic research data directly to the ad delivery device where multiple advertisements for one or more products in various languages are stored.

### TECHNICAL FIELD

The present disclosure relates to methods and apparatus for providing dynamic targeted advertisements using a portable device.

### BACKGROUND INFORMATION

There is considerable interest in providing audience member-targeted advertisements to increase sales and interest in a given product. The main objective of nearly every advertiser is to effectively communicate a particular message to as many audience members as possible. With advances in technology, and the ever shrinking globe, an advertiser is able to easily and economically communicate with people around the world. In doing so, an advertiser must overcome certain language barriers in order to effectively reach all intended customers. Until now, the most common solution to a language barrier was to display or broadcast a message in the predominant language of the targeted area (e.g. the location of advertisement, signage or broadcast). For example, advertisements and signage displayed or broadcast in an American metropolitan area would, by default, display or broadcast its message in the English language. Unfortunately, an advertisement's language is generally localized for a given market and not necessary for an individual or a group of individuals who may be exposed to that ad.

This is particularly troublesome in locations around that globe where multiple languages are spoken (e.g. airports, hotels, convention centers, tourist attractions and other public locations). As a further example, electronic signage in an airport or a hotel in the United States will generally and by default display its ads in the English language. However, if a group of Japanese tourists is standing near the signage, the ad will likely be more effective if it were in the Japanese language. Since airports worldwide handle over one billion travelers per year, advertisers miss an opportunity to communicate their products and/or services to millions of travelers merely due to language barriers.

The current solution to this problem is to present an advertisement or broadcast in multiple languages. A problem with this method is that a single message must be continually displayed or broadcast in a number of different languages. This method clearly leads to a number of redundant advertisements, in addition to wasted time and space caused by the redundant advertisements. Another issue is that advertisers are likely to only translate their advertisements in the most common languages to the area, leaving minority language speakers uninformed.

Therefore there is a need for an ad delivery system with integrated intelligence, allowing for the language of the ad to be dynamically adjusted to match the natural language being spoken in and around the ad delivery device (e.g. signage, radio, TV, PC, etc.). Similarly, there is a need for an ad delivery system with integrated intelligence, allowing for the type or subject of the ad to be dynamically adjusted to best match the topic being discussed in and around the ad delivery device (e.g. signage, radio, TV, PC, etc.).

### SUMMARY

Under an exemplary embodiment, a detection and identification system is integrated with a portable device, where a system for natural voice recognition is implemented within a portable device. A portable device may be a cell phone, smart phone, Personal Digital Assistant (PDA), media player/reader, computer laptop, tablet PC, or any other processor-based device that is known in the art, including a desktop PC and computer workstation.

The portable device employs voice recognition and/or encoding/decoding techniques which may be employed to gather, analyze and identify the media's content class, language being spoken, topic of conversation, and/or other information which may be useful in selecting targeted advertisements. The portable device uses this information to produce dynamic research data descriptive of the nearby natural languages and/or content. Once the portable device has produced dynamic research data, the portable device communicates any dynamic research data to a centralized server system server where the dynamic research data is processed and used to select the one or most suitable targeted advertisement. The selected targeted advertisement is then communicated to and/or inserted in the ad delivery device. Alternatively, the portable device may communicate dynamic research data directly to the ad delivery device where multiple advertisements for one or more products in various languages are stored. As in the centralized server system embodiment, the dynamic research data is processed and used to select the one or most suitable targeted advertisement. The selected targeted advertisement is then presented or displayed to one or more audience members.

For this application, the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data”, as used to represent predetermined information in one physical form, shall be deemed to encompass any and all representations of corresponding information in a different physical form or forms.

The term “media data” as used herein means data which is widely accessible, whether over-the-air, or via cable, satellite, network, internetwork (including the Internet), distributed on storage media, or otherwise, without regard to the form or content thereof, and including but not limited to audio, video, text, images, animations, web pages and streaming media data.

The term “presentation data” as used herein means media data or content other than media data to be presented to a user.

The term “ancillary code” as used herein means data encoded in, added to, combined with or embedded in media data to provide information identifying, describing and/or characterizing the media data, and/or other information useful as research data.

The terms “reading” and “read” as used herein mean a process or processes that serve to recover research data that has been added to, encoded in, combined with or embedded in, media data.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, function, activity or thing from another, and are not used to designate relative position, or arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means; (b) a communications relationship, whether direct or through one or more other devices, apparatus, files, circuits, elements, functions, operations, processes, programs, media, components, networks, systems, subsystems, or means; and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate” and “communicating” as used herein include both conveying data from a source to a destination, and delivering data to a communications medium, system, channel, network, device, wire, cable, fiber, circuit and/or link to be conveyed to a destination and the term “communication” as used herein means data so conveyed or delivered. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware, tangibly-embodied software or both, and whether or not programmable. The term “processor” as used herein includes, but is not limited to, one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage” and “data storage” as used herein mean one or more data storage devices, apparatus, programs, circuits, components, systems, subsystems, locations and storage media serving to retain data, whether on a temporary or permanent basis, and to provide such retained data.

The term “targeted advertisement” is a type of advertisement placed to reach consumers based on various traits such as demographics, purchase history, language, topic of conversation or other observed behavior.

The present disclosure illustrates systems and methods for voice recognition and/or encoding/decoding techniques within a portable device. Under various disclosed embodiments, a portable device is equipped with hardware and/or software to monitor any nearby audio, including spoken word as well as prerecorded audio. The portable device may use audio encoding technology to encode/decode the ancillary code within the source signal which can assist in producing gathered research data. The encoding automatically identifies, at a minimum, the source, language or other attributes of a particular piece of material by embedding an inaudible code within the content. This code contains information about the audio content that can be decoded by a machine, but is not detectable by human hearing. The portable device is connected between an ad delivery device (e.g., signage, radio, TV, PC, etc.) and an external source of audio, where the ad delivery device communicates the targeted advertisement to one or more audience members.

By monitoring nearby audio, an ad delivery device is manipulated to display and communicate a targeted advertisement. Providing targeted advertisements increases business by providing advertisements that are of interest to the particular audience member, and in a language comprehensible to the audience member. In certain embodiments, the technology may be used to simultaneously return applicable targeted advertisements on the portable device. Advertisers will be interested in using this technique to make their ads more effective by dynamically adjusting the ads' language to the spoken language at the receiving end. This technique can be used in direct, addressable advertising applications. This is especially of interest for mobile TV, cable TV (e.g. Project Canoe) and internet radio and TV.

### BRIEF DESCRIPTION OF THE DRAWINGS

FIG. 1 is a block diagram of a portable user device modified to produce dynamic research data;

FIG. 2 is a functional block diagram for use in explaining certain embodiments involving the use of the portable user device of FIG. 1.

FIG. 3 is an exemplary diagram of a first embodiment of a targeted advertisement system using a portable device;

FIG. 4 is an exemplary diagram of a second embodiment of a targeted advertisement system using a portable device;

FIG. 5 is a flow diagram representing the basic operation of software used for employing voice recognition techniques in a portable device; and

FIG. 6, is a flow diagram representing the basic operation of software used for selecting an advertisement.

### DETAILED DESCRIPTION

Various embodiments of the present invention will be described herein below with reference to the accompanying drawings. In the following description, well-known functions or constructions are not described in detail since they would obscure the invention with unnecessary detail.

Under an exemplary embodiment, a system is implemented in a portable device for gathering dynamic research data concerning the characteristics, topic and language of spoken word using voice recognition techniques and encoding/decoding techniques. The portable device may also be capable of encoding and decoding broadcasts or recorded segments such as broadcasts transmitted over the air, via cable, satellite or otherwise, and video, music or other works distributed on previously recorded. An exemplary process for producing dynamic research data comprises transducing acoustic energy to audio data, receiving media data in non-acoustic form in a portable device and producing dynamic research data based on the audio data, and based on the media data and/or metadata of the media data.

When audio data is received by the portable device, which in certain embodiments comprises one or more processors, the portable device forms signature data characterizing the audio data, which preferably includes information pertaining to a language component for the audio data (e.g., what language is being used in the audio data). Suitable techniques for extracting signatures from audio data are disclosed in U.S. Pat. No. 5,612,729 to Ellis, et al. and in U.S. Pat. No. 4,739,398 to Thomas, et al., each of which is assigned to the assignee of the present invention and both of which are incorporated by reference in their entirety herein.

Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al, U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,531 to Kenyon, et al., U.S. Pat. No. 4,230,990 to Lert, et al., U.S. Pat. No. 5,594,934 to Lu, et al., and PCT publication WO91/11062 to Young, et al., all of which are incorporated by reference in their entirety herein.

Specific methods for forming signature data include the techniques described below. It is appreciated that this is not an exhaustive list of the techniques that can be used to form signature data characterizing the audio data.

In certain embodiments, audio signature data may be formed by using variations in the received audio data. For example, in some of these embodiments, the signature is formed by forming a signature data set reflecting time-domain variations of the received audio data, which set, in some embodiments, reflects such variations of the received audio data in a plurality of frequency sub-bands of the received audio data. In others of these embodiments, the signature is formed by forming a signature data set reflecting frequency-domain variations of the received audio data.

In certain other embodiments, audio signature data may be formed by using signal-to-noise ratios that are processed for a plurality of predetermined frequency components of the audio data and/or data representing characteristics of the audio data. For example, in some of these embodiments, the signature is formed by forming a signature data set comprising at least some of the signal-to-noise ratios. In others of these embodiments, the signature is formed by combining selected ones of the signal-to-noise ratios. In still others of these embodiments, the signature is formed by forming a signature data set reflecting time-domain variations of the signal-to-noise ratios, which set, in some embodiments, reflects such variations of the signal-to-noise ratios in a plurality of frequency sub-bands of the received audio data, which, in some such embodiments, are substantially single frequency sub-bands. In still others of these embodiments, the signature is formed by forming a signature data set reflecting frequency-domain variations of the signal-to-noise ratios.

In certain other embodiments, the signature data is obtained at least in part from code in the audio data, such as a source identification code, as well as language code. In certain of such embodiments, the code comprises a plurality of code components reflecting characteristics of the audio data and the audio data is processed to recover the plurality of code components. Such embodiments are particularly useful where the magnitudes of the code components are selected to achieve masking by predetermined portions of the audio data. Such component magnitudes therefore, reflect predetermined characteristics of the audio data, so that the component magnitudes may be used to form a signature identifying the audio data.

In some of these embodiments, the signature is formed as a signature data set comprising at least some of the recovered plurality of code components. In others of these embodiments, the signature is formed by combining selected ones of the recovered plurality of code components. In yet other embodiments, the signature can be formed using signal-to-noise ratios processed for the plurality of code components in any of the ways described above. In still further embodiments, the code is used to identify predetermined portions of the audio data, which are then used to produce the signature using any of the techniques described above. It will be appreciated that other methods of forming signatures may be employed.

After the signature data is formed in a portable device 100, it is communicated to a reporting system, which may be part of a centralized server system 324, which processes the signature data to produce data representing the identity of the program segment. While the portable device and reporting system are preferably separate devices, this example serves only to represent the path of the audio data and derived values, and not necessarily the physical arrangement of the devices. For example, the reporting system may be located at the same location as, either permanently or temporarily/intermittently, or at a location remote from, the portable device. Further, the portable device and the reporting system may be, or be located within, separate devices coupled to each other, either permanently or temporarily/intermittently, or one may be a peripheral of the other or of a device of which the other is a part, or both may be located within, or implemented by, a single device.

In some instances, voice recognition technologies may be integrated with the portable device to produce language data. This combination easily enables the portable device to identify the radio or TV station from which the ad is broadcasted, and to send the language information directly to the cable/broadcasters where the language of the advertisement may be dynamically adjusted to match the spoken language in a household, even though the program may be in a different language.

For example, if a TV program is being viewed in English, but the portable device reports that the dominant spoken language at the time of broadcast is Spanish, the commercials during that program may be dynamically adjusted to be in Spanish targeted for each specific household. Similarly, targeted advertisements may be presented based on the content of the family dialogue, as determined by the portable device. In this case, if the family members were discussing the need for a new car, one or more car advertisements may be presented in the language spoken by the family.

Portable devices are ideal for implementing voice recognition and encoding techniques. This is because most portable devices already include the required hardware (memory, processor, microphone and communication means); thus all that would need to be done is a simple installation of voice or language recognition software (e.g. a smartphone can use the phone's microphone to listen to the spoken words around it and identify the dominant spoken language).

There are a number of suitable voice recognition techniques for producing language data. Voice recognition may be generally described as the technology where sounds, words or phrases spoken by humans are converted into electrical signals. These signals are then transformed into coding patterns that have pre-assigned meanings. Most common approaches to voice recognition can be divided into two general classes—template matching and feature analysis.

Template matching is the simplest technique and has the highest accuracy when used properly, but it also suffers from the most limitations. The largest limitation is that template matching is a speaker-dependent system, that is, the program must be trained to recognize each speaker's voice. The program is trained by having each user speak a set of predefined words and/or phrases. Training is necessary because human voices are very inconsistent from person to person. However, there are a number of benefits to template matching, including a vocabulary of a few hundred words and short phrases with recognition accuracy around 98 percent.

A preferred voice recognition technique would be speaker independent, such as the more general form of voice recognition feature analysis. Rather than attempting to find an exact or near-exact match between the actual voice input and a previously stored voice template, this method first processes the voice input using Fourier transforms or linear predictive coding (LPC), then attempts to find characteristic similarities between the expected inputs and the actual digitized voice input. These similarities will be present for a wide range of speakers, and so the system need not be trained by each new user. The types of speech differences that the speaker-independent method can deal with, but which pattern matching would fail to handle, include accents, and varying speed of delivery, pitch, volume, and inflection. Speaker-independent speech recognition has proven to be very difficult, with some of the greatest hurdles being the variety of accents and inflections used by speakers of different nationalities. Recognition accuracy for speaker-independent systems is somewhat less than for speaker-dependent systems, usually between 90 and 95 percent.

An exemplary speaker independent speech recognition system for producing language data is based on Hidden Markov Models (HMM), models which output a sequence of symbols or quantities. HMMs are used in speech recognition because a speech signal can be viewed as a piecewise stationary signal or a short-time stationary signal. Another reason why HMMs are popular is because they can be trained automatically and are simple and computationally feasible to use, allowing for speaker-independent applications. In speech recognition, the hidden Markov model would output a sequence of n-dimensional real-valued vectors (with n being a small integer, such as 10), outputting one of these every 10 milliseconds. The vectors would consist of cepstral coefficients, which are obtained by taking a Fourier transform of a short time window of speech and decorrelating the spectrum using a cosine transform, then taking the first (most significant) coefficients. The hidden Markov model will tend to have in each state a statistical distribution that is a mixture of diagonal covariance Gaussians which will give a likelihood for each observed vector. Each word, or for more general speech recognition systems, each phoneme, will have a different output distribution; a hidden Markov model for a sequence of words or phonemes is made by concatenating the individually trained hidden Markov models for the separate words and phonemes.

Described above are the core elements of the most common HMM-based approaches to speech recognition. Modern speech recognition systems use various combinations of a number of standard techniques in order to improve results over the basic approach described above. For further information on voice recognition development, testing, basics and the state of the art for ASR, see the recently updated textbook of “Speech and Language Processing (2008)” by Jurafsky and Martin available from Pearson Publications, ISBN-10: 0131873210.

Other techniques for language identification includes the steps of extracting high-end phonetic information from spoken utterances, and use it to discriminate among a closed set of languages. One specific technique is referred to as “Parallel Phone Recognition and Language Modeling” (PPRLM), where a set of phone recognizers are used to produce multiple phone sequences (one for each recognizer), which are later scored using n-gram language models. Another technique is referred to as a Gaussian Mixture Model (GMM) which often incorporates Shifted Delta Cepstra (SDC) features. SDC are derived from the cepstrum over a long span of time-frames, and this enables the frame independent GMM to model long time-scale phenomena, which are likely to be significant for identifying languages. The advantage of GMM utilizing SDC features is that it requires much less computational resources.

Yet another technique for language recognition involves the use of speech segmentation, where prosodic cues (temporal trajectories of a short-term energy and fundamental frequency), as well as coarse phonetic information (broad-phonetic categories), are used to segment and label a speech signal into a relatively small number of classes, e.g.:

Unvoiced segment

Rising frequency and rising energy;

Rising frequency and falling energy

Falling frequency and rising energy

Falling frequency and falling energy

Such strings of labeled sub-word units can be used for building statistical models that can be used to characterize speakers and/or languages.

Different speakers/languages may be characterized by different intonation or rhythm patterns produced by the changes in pitch and in sub-glottal pressure, as well as by different sounds of language: tone languages (e.g., Mandarin Chinese), pitch-accent languages (e.g., Japanese), stress-accent languages (e.g., English and German), etc. Accordingly, the combination of pitch, sub-glottal pressure, and duration that characterizes particular prosodic cues, together with some additional coarse description of used speech sounds, may be used to extract speaker/language information.

During segmentation, a continuous speech signal is converted into a sequence of discrete units that describe the signal in terms of dynamics of the frequency temporal trajectory (i.e., pitch), the dynamics of short-term energy temporal trajectory (i.e., subglottal pressure), and possibly also the produced speech sounds, could be used in for building models that that may characterize given speaker and/or language. The speech segmentation may be performed according to the following steps: (1) compute the frequency and energy temporal trajectories, (2) compute the rate of change for each trajectory, (3) detect the inflection points (points at the zero-crossings of the rate of change) for each trajectory, (4) segment the speech signal at the detected inflection points and at the voicing starts or ends, and (5) convert the segments into a sequence of symbols by using the rate of change of both trajectory within each segment. Such segmentation is preferably performed over an utterance (i.e., a period of time when one speaker is speaking.

The rate-of-change of the frequency and energy temporal trajectories is estimated using their time derivatives. The time derivatives are estimated by fitting a straight line to several consecutive analysis frames (the method often used for estimation of so called “delta features” in automatic speech recognition). Utterances may be segmented at inflection points of the temporal trajectories or at the start or end of voicing. First, the inflection points are detected for each trajectory at the zero crossings of the derivative, Next, the utterance is segmented using the inflection points from both time contours and the start and end of voicing. Finally, each segment is converted into a set of classes that describes the joint-dynamics of both temporal trajectories.

As with any approach to voice recognition, the first step is for the user to speak a word or phrase into a microphone. The electrical signal from the microphone is digitized by an analog-to-digital (A/D) converter, and is stored in memory. To determine the “meaning” of this voice input, the processor attempts to match the input with a digitized voice sample or template that has a known meaning.

With respect to language detection, if multiple languages are recognized, the system will select the majority-spoken language or the loudest spoken language. The dynamic ad delivery system or centralized server system will require a heuristic component to decide whether or not to dynamically change the language and also to decide amongst several spoken language proximate to an ad delivery device at the end point. In certain instances, the primary language of an ad may continue to be displayed in a separate window while the dynamically selected language may be displayed/played in another window. This is particularly useful in visual displays, such as signage.

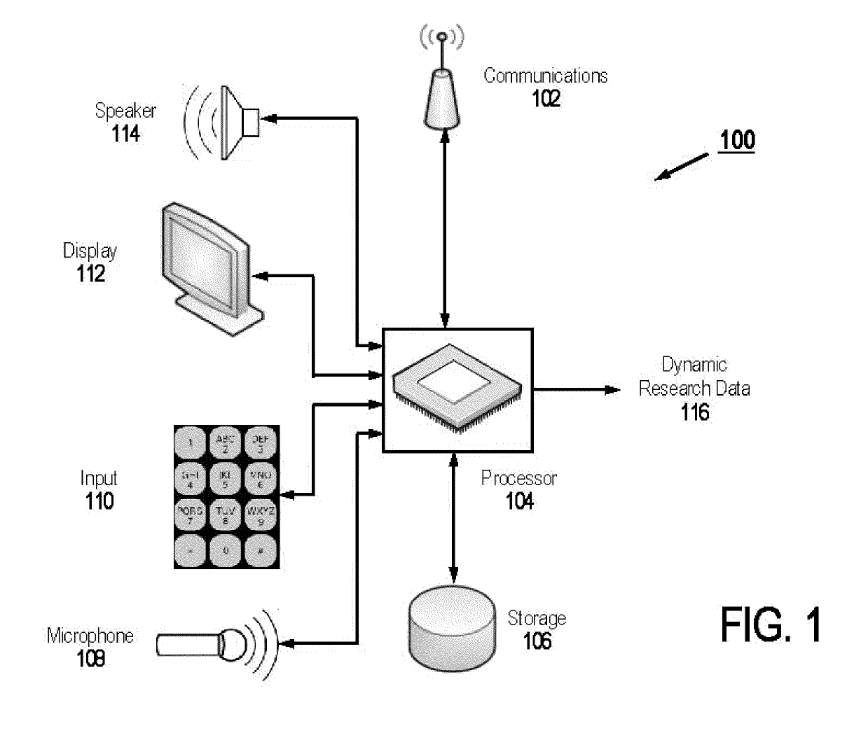

FIG. 1 is a block diagram of a portable user device 100 modified to produce dynamic research data 116. The portable user device 100 may be comprised of a processor 104 that is operative to exercise overall control and to process audio and other data for transmission or reception, and communications 102 coupled to the processor 104 and operative under the control of processor 104 to perform those functions required for establishing and maintaining a two-way wireless communication link with a portable user device network. In certain embodiments, processor 104 also is operative to execute applications ancillary or unrelated to the conduct of portable user device communications, such as applications serving to download audio and/or video data to be reproduced by portable user device 100, e-mail clients and applications enabling the user to play games using the portable user device 100. In certain embodiments, processor 104 comprises two or more processing devices, such as a first processing device (such as a digital signal processor) that processes audio, and a second processing device that exercises overall control over operation of the portable user device 100. In certain embodiments, processor 104 employs a single processing device. In certain embodiments, some or all of the functions of processor 104 are implemented by hardwired circuitry.

Portable user device 100 is further comprised of storage 106 coupled with processor 104 and operative to store data as needed. In certain embodiments, storage 106 comprises a single storage device, while in others it comprises multiple storage devices. In certain embodiments, a single device implements certain functions of both processor 104 and storage 106.

In addition, portable user device 100 includes a microphone 108 coupled with processor 104 to transduce audio to an electrical signal, which it supplies to processor 104 for voice recognition or encoding, and speaker and/or earphone 114 coupled with processor 104 to transduce received audio from processor 104 to an acoustic output to be heard by the user. Portable user device 100 may also include user input 110 coupled with processor 104, such as a keypad, to enter telephone numbers and other control data, as well as display 112 coupled with processor 104 to provide data visually to the user under the control of processor 30.

In certain embodiments, portable user device 100 provides additional functions and/or comprises additional elements. In certain examples of such embodiments, portable user device 100 provides e-mail, text messaging and/or web access through its wireless communications capabilities, providing access to media and other content. For example, Internet access by portable user device 100 enables access to video and/or audio content that can be reproduced by the cellular telephone for the user, such as songs, video on demand, video clips and streaming media. In certain embodiments, storage 106 stores software providing audio and/or video downloading and reproducing functionality, such as iPod™ software, enabling the user to reproduce audio and/or video content downloaded from a source, such as a personal computer via communications 102 or through direct Internet access via communications 102.

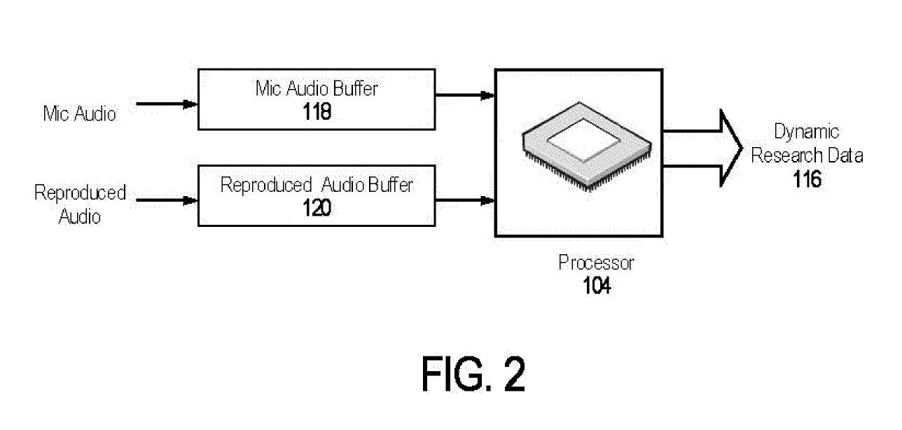

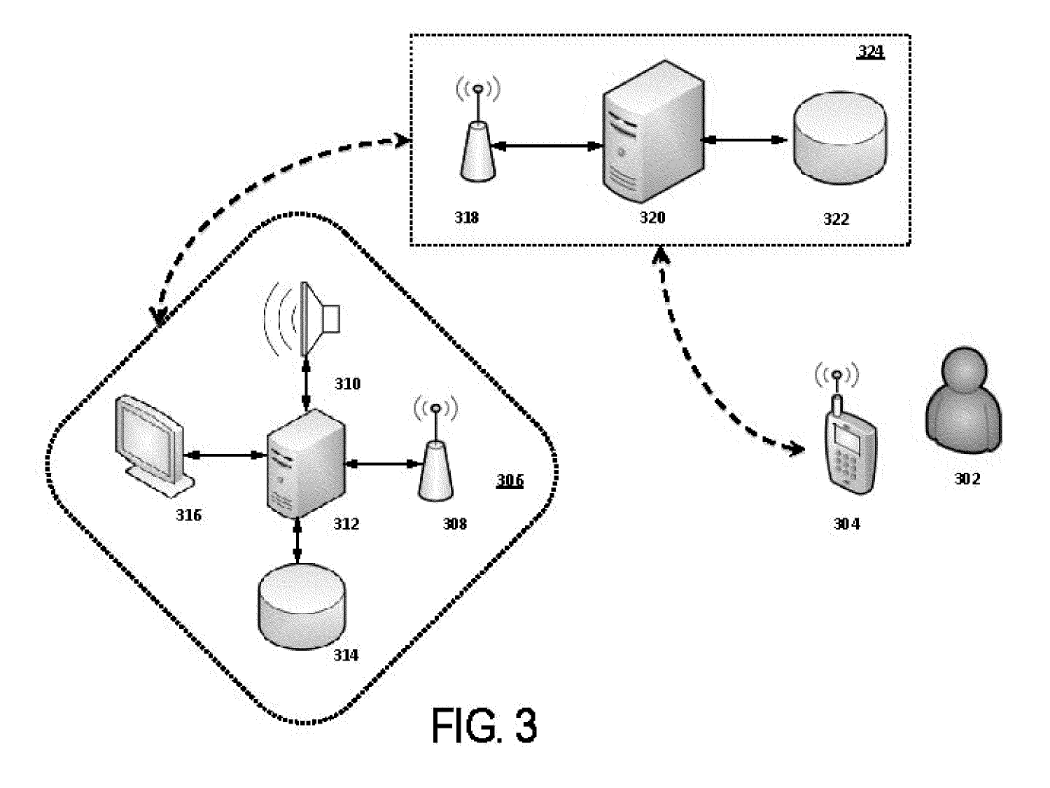

To enable portable user device 100 to produce dynamic research data (e.g., data representing the spoken language, topics or other content traits), in certain embodiments dynamic research software is installed in storage 106 to control processor 104 to gather such data and communicate it via communications 102 to a centralized server system (FIG. 2.) or directly to an ad delivery device (FIG. 3).

In certain embodiments, dynamic research software controls processor 30 to perform voice recognition on the transduced audio from microphone 108 using one or more of the known techniques identified hereinabove, and then to store and/or communicate dynamic research data for use as research data indicating details specific to audio to which the user was exposed. In certain embodiments, dynamic research software controls processor 30 to decode ancillary codes in the transduced audio from microphone 108 using one or more of the known techniques identified hereinabove, and then to store and/or communicate the decoded data for use as research data indicating encoded audio to which the user was exposed. In certain embodiments, dynamic research software controls processor 104 to extract signatures from the transduced audio from microphone 108 using one or more of the known techniques identified hereinabove, and then to store and/or communicate the extracted signature data for use as research data to be matched with reference signatures representing known audio to detect the audio to which the user was exposed. In certain embodiments, the research software both decodes ancillary codes in the transduced audio and extracts signatures therefrom for identifying the audio to which the user was exposed. In certain embodiments, the research software controls processor 104 to store samples of the transduced audio, either in compressed or uncompressed form for subsequent processing either to decode ancillary codes therein or to extract signatures therefrom. In certain examples of these embodiments, compressed or uncompressed audio is communicated to a remote processor for decoding and/or signature extraction.

Where portable user device 100 possesses functionality to download and/or reproduce presentation data, in certain embodiments dynamic research data concerning the usage and/or exposure to such presentation data, as well as audio data received acoustically by microphone 108, is gathered by portable user device 108 in accordance with the technique illustrated by the functional block diagram of FIG. 2. Storage 106 of FIG. 1 implements an audio buffer 118 for audio data gathered with the use of microphone 108. In specific instances for these embodiments, storage 106 implements a buffer 120 for presentation data downloaded and/or reproduced by portable user device 100 to which the user is exposed via speaker and/or earphone 118 or display 112, or by means of a device coupled with portable user device 100 to receive the data therefrom to present it to a user. In some of such embodiments, reproduced data is obtained from downloaded data, such as songs, web pages or audio/video data (e.g., movies, television programs, video clips). In some of such embodiments, reproduced data is provided from a device such as a broadcast or satellite radio receiver of the portable user device 100 (not shown for purposes of simplicity and clarity). In certain cases, storage 106 implements buffer 120 for metadata of presentation data reproduced by portable user device 100 to which the user is exposed via speaker and/or earphone 118 or display 112, or by means of a device coupled with portable user device 100 to receive the data therefrom to present it to a user. Such metadata can be, for example, a URL from which the presentation data was obtained, channel tuning data, program identification data, an identification of a prerecorded file from which the data was reproduced, or any data that identifies and/or characterizes the presentation data, or a source thereof. Where buffer 120 stores audio data, buffers 118 and 120 store their audio data (either in the time domain or the frequency domain) independently of one another. Where buffer 120 stores metadata of audio data, buffer 118 stores its audio data (either in the time domain or the frequency domain) and buffer 120 stores its metadata, each independently of the other.

Processor 104 separately produces dynamic research data 116 from the contents of each of buffers 118 and 120 which it stores in storage 106. In certain examples of these embodiments, one or both of buffers 118 and 120 is/are implemented as circular buffers storing a predetermined amount of audio data representing a most recent time interval thereof as received by microphone 108 and/or reproduced by speaker and/or earphone 112, or downloaded by portable user device 100 for reproduction by a different device coupled with portable user device 100. Processor 104 extracts signatures and/or decodes ancillary codes in the buffered audio data to produce research data. Where metadata is received in buffer 120, in certain embodiments the metadata is used, in whole or in part, as dynamic research data 116, or processed to produce dynamic research data 116. Dynamic research data is thus gathered representing exposure to and/or usage of audio data by the user where audio data is received in acoustic form by portable user device 100 and where presentation data is received in non-acoustic form (for example, as a cellular telephone communication, an electrical signal via a cable from a personal computer or other device, a broadcast or satellite signal or otherwise).

Turning to FIG. 3, an exemplary diagram of a first embodiment of a targeted advertisement system using a portable device is shown. In a first embodiment, a portable device 304, as described in FIG. 1, monitors and analyzes audience member 302s spoken word and other proximate audio. Portable device 304 may be carried on audience member 302's person or merely located within a range that enables the portable device 304 to identify sounds created by audience member 302. In operation, portable device 304 continuously monitors audio by employing voice/language recognition and/or encoding/decoding technologies to create dynamic research data 116.

In certain advantageous embodiments, database 322 may also contain reference audio signature data of identified audio data. After audio signature data is formed in the portable device 304, it is compared with the reference audio signature data contained in the database 322 in order to identify the received audio data.

There are numerous advantageous and suitable techniques for carrying out a pattern matching process to identify the audio data based on the audio signature data. Some of these techniques are disclosed in U.S. Pat. No. 5,612,729 to Ellis, et al. and in U.S. Pat. No. 4,739,398 to Thomas, et al., disclosed above and incorporated herein by reference.

Still other suitable techniques are the subject of U.S. Pat. No. 2,662,168 to Scherbatsoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,531 to Kenyon, et al., U.S. Pat. No. 4,230,990 to Lert, et al., U.S. Pat. No. 5,594,934 to Lu et al., and PCT Publication WO91/11062 to Young et al., all of which are incorporated herein by reference.

Dynamic research data 116 is communicated to centralized server system 324. Centralized server system 324 includes processor 320, media storage 322 and wireless communication transmitter 318. Media storage 312 includes one or more multimedia data files representing advertisements for a plurality of different products or services in various languages. To classify the multimedia data files stored to the media storage 312, each may each have one or more tags assigned to it. For example, a multimedia data file representing a French language advertisement for a trendy teen clothing store may have tags such as “French language”, “Teen”, “Retail-Clothing” among other descriptive tags, whereas the same advertisement, but in English, would have an “English language” tag in lieu of the “French language” tag.

In this case, the method of multimedia tagging is useful because each multimedia data file can be assigned a plurality of tags, thus allowing a single multimedia file to be placed into more than one content category. Examples of suitable tagging includes (1) folksonomy tagging, (2) MPEG-7 tagging, which relies on collaborative indexing based on semantic MPEG-7 basetypes, e.g., agent, event, concept, object, place, time, state, etc.; (3) Commsonomies, which utilize community-aware multimedia folksonomies and support annotations of multimedia contents, freetext annotations, MPEG-7 based semantic basetypes, community-specific storage & retrieval, cross-community content sharing and MPEG-7 compliance; and (4) MPEG-7 Multimedia Tagging (M7MT) which supports collaborative indexing based on keyword annotations, semantic MPEG-7 basetypes and community-aware folksonomies

Other examples of tagging techniques, including computerized tagging for both subjective and non-subjective media, where a semantic and/or symbolic distances are calculated to establish a “focal point” (also referred to as a Schelling point) for a plurality of content. Initially, data is processed to obtain data characteristics (e.g., author, tag(s), category, link(s), etc.). Next, feature space dimensions are determined by evaluating the content to determine a distance from a predetermined set of categories. The distance measurement of the content from a category is based on semantic distance, i.e. how closely the content is associated to the category on semantic grounds, and symbolic distance, i.e. considering tags as mere symbols rather than words with some meanings to evaluate how similar content is, symbolically, to a predetermined category. For every category, the associations are based on a thesaurus tree, which forms the basis for a hierarchical evaluation (i.e., weighting) when determining distances. From this, a matrix may be formed to establish feature vectors and resulting focal point. Further details regarding this technique may be found in Sharma, Ankier & Elidrisi, Mohamed, “Classification of Multi-Media Content (Videos on YouTube) Using Tags and Focal Points”, http://www-users.cs.umn.edu/˜ankur/FinalReport_PR-1.pdf, which is incorporated herein in its entirety.

Centralized server system 324 receives the dynamic research data via the transmitter 318. Dynamic research data 116 is processed and/or analyzed by processor 320, which uses the dynamic research data 116 to form a control signal to select one or more advertisements that best match dynamic research data 116. These one or more targeted advertisements, in the form of one or more multimedia data files, are communicated from centralized server system 324 to ad delivery device 306. The ad delivery device 306 is comprised of a processor, 312, one or more wireless transmitters 308, storage 314 and audio visual devices, such as display 316 and/or speaker 310. The communication means between centralized server system 324 and the ad delivery system 306 may be either wired, wireless or both. Ad delivery system 306 uses storage 314 to store, among other data, any targeted advertisements from the centralized server. These targeted advertisements may be displayed using display 316. If there is a audio component, speaker 310 may be used to convert the audio signal back to audible sound. In some instances, both speaker 310 and the display may be used simultaneously, while in other instances, only one of the devices may be needed for presenting the advertisement. In certain embodiments, depending on the needs of the advertisement, ad delivery system 306 may contain a plurality of speakers 310 and/or displays 316.

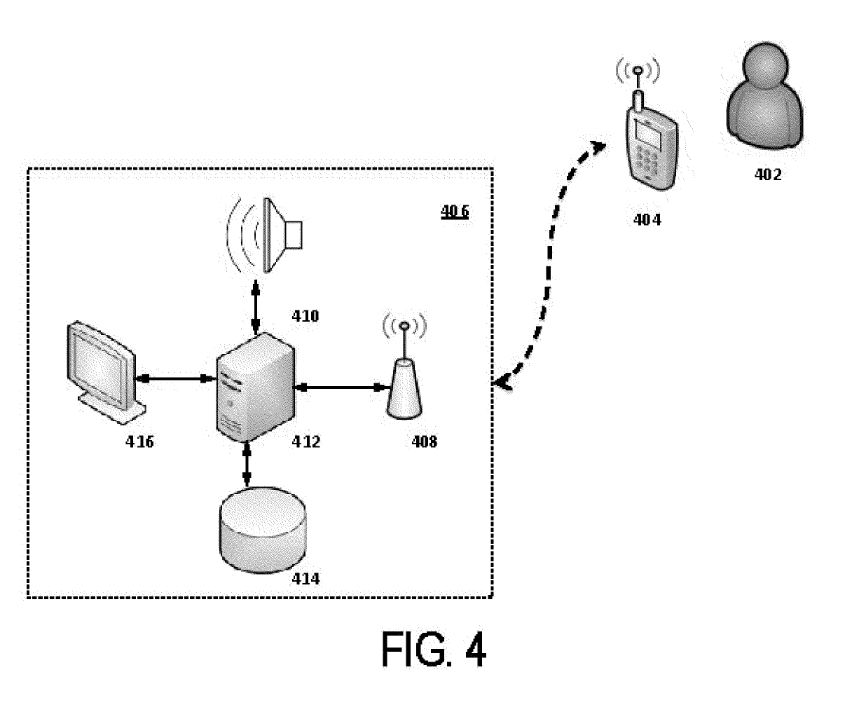

Referring now to FIG. 4, an exemplary diagram of a second embodiment of a targeted advertisement system using a portable device is shown. As disclosed in FIG. 3, portable device 304 monitors and analyzes audience member 302's spoken word and other proximate audio. Portable device 304 may be carried on audience member 302's person or merely located within a range that enables the portable device 304 to identify sounds created by audience member 302. In operation, portable device 304 continuously monitors audio by employing voice recognition and/or encoding/decoding technologies to create dynamic research data 116.

However, unlike the first embodiment of FIG. 3, dynamic research data 116 is wirelessly communicated directly to ad delivery device 406. Ad delivery device 406 includes a processor 412, storage 414, wireless communication transmitter 408 and audio visual devices, such as display 416 and/or speaker 410. The communication means between portable device 404 and ad delivery system 406 may be either wired, wireless or a combination of both.

Ad delivery device 406 receives dynamic research data via the transmitter 408. Dynamic research data 116 is processed and/or analyzed by processor 412 which uses dynamic research data 116 to select one or more advertisements that best match dynamic research data 116. These targeted advertisements may be displayed using display 416. If there is an audio component, speaker 410 may be used to convert the audio signal back to audible sound. In some instances, both speaker 410 and display 416 may be used simultaneously, while in other instances, only one of the devices may be needed for presenting the advertisement. In certain embodiments, ad delivery system 406 may contain a plurality of speakers 410 and/or displays 416.

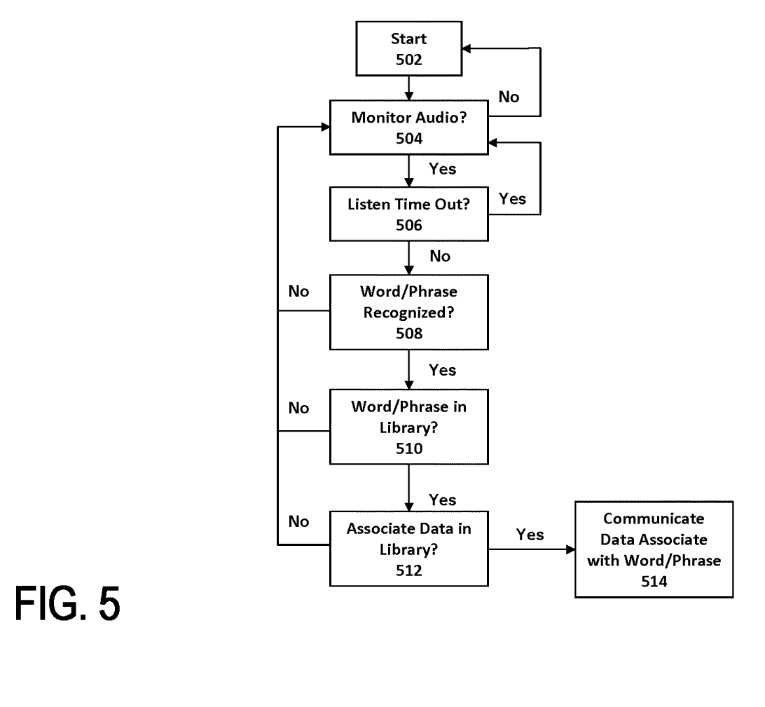

Referring now to FIG. 5, a flow diagram representing the basic operation of software running on a portable device is depicted. The operation may start 502 either when the portable device is activated or when a monitoring program is loaded. Similarly, the monitor audio 504 option may be automatically employed with activation of the portable device or loading of the program. Alternatively, an option to monitor audio 504 may be presented to the portable device user, advertiser, service, ad delivery device, or other device allowing for more selective monitoring. A listen time out 506 may be employed if the portable device is unable to detect audio for a predetermine amount of time (e.g. 1 to 15 minutes). If the listen time out 506 is enabled, the operation is paused until a monitor audio 504 command is returned. If listen time out 506 is not enabled, the program determines whether a phrase or word is recognized 508. If the word or phrase is not recognized 508, the program makes an attempt to continue monitoring until a word is recognized. In certain embodiments, a counter or clock may be used to stop the program if no words or phrases are recognized after a certain number of attempts or a certain period of time. This would be particularly useful in cases where the portable device is attempting to monitor random noise, static or an unrecognizable language.

Once a word is recognized 508, the operation checks a library, which may be stored to the portable device's storage or at some remote location, to determine whether that word of phrase is in the library 510. Once the software determines that a word or phrase is in the library 510, the software then determines whether there is data associated 512 with that word or phrase. Associated data may include the language of the word (e.g. English, Spanish, Japanese, etc.), a definition of the word or phrase, the topic of the word or phrase used in conversation (e.g. travel, food, automotive, etc.) or other descriptive qualities.

If there is no associated data, the software continues to monitor the audio. If there is associated data in the library, the associated data is communicated to a centralized server system, a server, network or directly to an ad deliver device. In certain embodiments, the associated data may be used by the portable device to provide targeted advertisements or other associated advertisements which may be displayed or broadcasted on the same, or nearby, portable device.

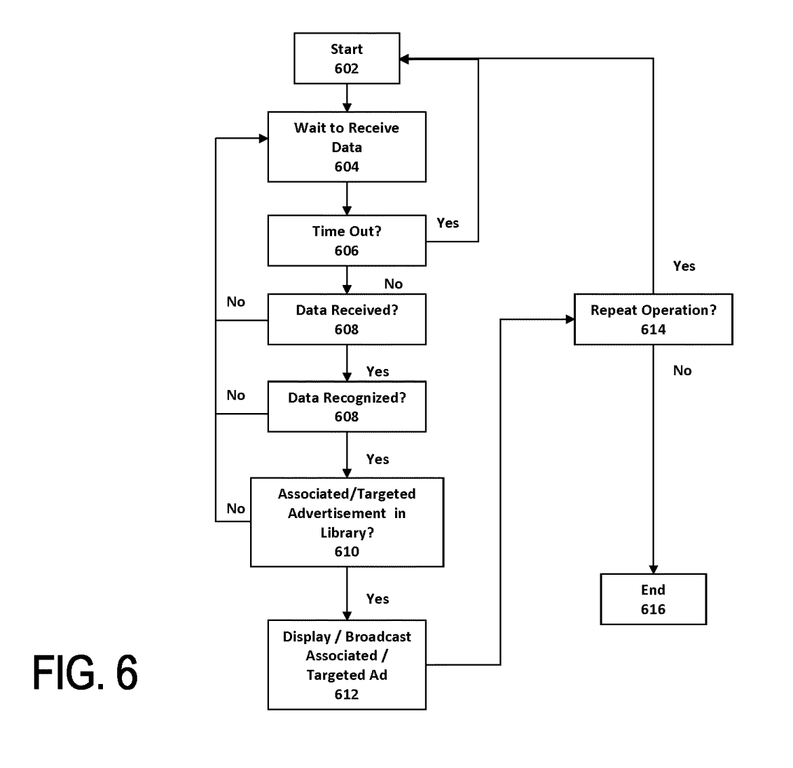

Referring now to FIG. 6, a flow diagram representing the basic operation of software used for selecting a targeted advertisement or other associated advertisement. The operation may start 602 either when the device receiving the data is activated or automatically employed with the reception of data. Alternatively, the operation may be started 602 by providing the portable device user, advertiser, service, ad delivery device, or other device allowing for more selective monitoring with the option to start 602 the operation. The operation then waits to receive data 604. The data being received may be the associated data created by the portable device (as shown in FIG. 5) or other data useful in selecting an advertisement (e.g. data received/extracted from an encoded broadcasts).

A time out 606 function may be employed if data has not been received within a predetermine amount of time (e.g. 30 to 60 minutes). If the time out 606 is enabled, the operation is paused until a start 602 command is returned. Alternatively, the program may be set to automatically try again after a certain time period. If time out 606 is not enabled, the program determines whether data has been received 608. If no data has been received 604, the operation returns to the start 602 and/or continues to wait until data has been received. If the data is received 608, the operation determines whether the data is recognized. If the data is not recognized 608, the operation returns to the start 602 and/or continues to wait until recognizable data has been received. If the data is recognized 608, the operation submits a request containing ad specifications, based on the recognized data, to search the device's storage library 610 for a targeted or associated advertisement. As disclosed, storage library includes one or more advertisements in various languages. An associated advertisement is an advertisement that contains specifications matching those of the request. For example, if an advertisement is being display in English, but the data received indicates that Japanese is being spoken, the operation will check the library for a Japanese language version of the same advertisement.

In another example, if the device receives data indicating that Japanese is being spoken and the topic relates to restaurants, the operation may check the library for targeted advertisement such as Japanese-language restaurant advertisements.

As previously discussed, organizing the library may be done by pre-tagging the advertisements or by other data classification methods. If the operation is unable to locate a targeted or associated advertisement containing all or more aspects of the request, the operation may choose an advertisement that best fits the request (e.g. contains the more aspects of the request that the other available advertisements). For example, building upon the previous example, if the operation is unable to find a Japanese language restaurant advertisement, other Japanese language advertisements may be returned. Alternatively, the operation may wait until additional or different data is received 604.

If an associated advertisement is located in the library, the operation causes the associated ad to be display on an ad delivery device. Once the associated advertisement has been display, the entire operation repeats unless the operation is cause to be ended (e.g. via command from the user, ad deliver device, advertiser, time out operation etc.).

Although various embodiments of the present invention have been described with reference to a particular arrangement of parts, features and the like, these are not intended to exhaust all possible arrangements or features, and indeed many other embodiments, modifications and variations will be ascertainable to those of skill in the art.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for controlling delivery of media data, comprising the steps of:
receiving signature data from a portable device, wherein the signature data characterizes the media data;
receiving language data from the portable device, wherein the language data indicates a language being spoken in the vicinity of the portable device;
determining a language component for the media data using at least a portion of the signature data;
determining if the language data is different from the language component for the media data; and
communicating a control signal for selecting new media data, based on the language data, if the language data is different from the language component for the media data.

2. The method of claim 1, wherein the signature data is formed using at least one of (a) time-domain or (b) frequency-domain variations of the media data.

3. The method of claim 1, where in the signature data is formed using signal-to-noise ratios that are processed for one of (a) a plurality of predetermined frequency components of the media data, or (b) data representing characteristics of the media data.

4. The method of claim 1, wherein the signature data is obtained at least in part from code in the media data, wherein the code comprises a plurality of code components reflecting characteristics of the media data.

5. The method of claim 1, wherein the language data is formed from a statistical distribution of coefficients obtained from a transformed sequence of n-dimensional real-valued vectors.

6. The method of claim 1, wherein the language data is formed using one of (a) parallel phone recognition and language modeling, (b) gaussian mixture model, and (c) gaussian mixture model incorporating shifted delta cepstra features.

7. The method of claim 1, wherein the media data comprises multimedia tagging data.

8. The method of claim 7, wherein the multimedia tagging data comprises one of (a) folsonomy tagging, (b) MPEG-7 tagging, (c) commsonomy tagging, or (d) MPEG-7 multimedia tagging.

9. The method of claim 7, wherein the control signal is based at least in part on the multimedia tagging data.

10. A system for controlling delivery of media data, comprising:
A centralized server system comprising a communication input that receives (a) signature data from a portable device, wherein the signature data characterizes the media data, and (b) language data from the portable device, wherein the language data indicates a language being spoken in the vicinity of the portable device;
wherein the centralized server system determines a language component for the media data using at least a portion of the signature data, and further determines if the language data is different from the language component for the media data; and
wherein the centralized server system comprises a communication output that communicates a control signal for selecting new media data, based on the language data, if the language data is different from the language component for the media data.

11. The system of claim 1, wherein the signature data from the portable device is formed using at least one of (a) time-domain or (b) frequency-domain variations of the media data.

12. The system of claim 1, where in the signature data from the portable device is formed using signal-to-noise ratios that are processed for one of (a) a plurality of predetermined frequency components of the media data, or (b) data representing characteristics of the media data.

13. The system of claim 1, wherein the signature data from the portable device is obtained at least in part from code in the media data, wherein the code comprises a plurality of code components reflecting characteristics of the media data.

14. The system of claim 1, wherein the language data from the portable device is formed from a statistical distribution of coefficients obtained from a transformed sequence of n-dimensional real-valued vectors.

15. The system of claim 1, wherein the language data from the portable device is formed using one of (a) parallel phone recognition and language modeling, (b) gaussian mixture model, and (c) gaussian mixture model incorporating shifted delta cepstra features.

16. The system of claim 1, wherein the media data comprises multimedia tagging data.

17. The system of claim 7, wherein the multimedia tagging data comprises one of (a) folsonomy tagging, (b) MPEG-7 tagging, (c) commsonomy tagging, or (d) MPEG-7 multimedia tagging.

18. The system of claim 7, wherein the control signal is based at least in part on the multimedia tagging data.

19. A method for producing dynamic research data in a portable device, comprising the steps of:
receiving media data at an input of the portable device;
producing signature data characterizing the media data, wherein the signature data is derived from at least a part of the media data;
producing language data, wherein the language data indicates a language being spoken in the vicinity of the portable device;
determining a language component for the media data using at least a portion of the signature data; and
transmitting the signature data and language component.

20. The method of claim 19, further comprising the step of receiving multimedia tagging data corresponding to the media data, and transmitting the multimedia tagging data together with the signature data and language component.
